(19) United States
(12) Patent Application Publication
(10) Pub. No.: US 2008/0229219 A1
(43) Pub. Date: Sep. 18, 2008

(54) CLIPBOARD HANDLING OF USER INTENT FOR CLIPBOARD OBJECTS

(76) Inventor: Naveenkumar V. Muguda, Cary, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/687,090

(22) Filed: Mar. 16, 2007

(51) Int. Cl. G06F 3/048

(52) U.S. Cl. 715/763; 715/767

(57) ABSTRACT

Embodiments of the present invention address deficiencies of the art in respect to clipboard object management and provide a novel and non-obvious method, system and computer program product for clipboard handling of object intent for clipboard objects. In one embodiment of the invention, a clipboard data processing system can be configured for clipboard handling of object intent for clipboard objects. The system can include a clipboard agent managing a clipboard in an operating platform. The system further can include clipboard object intent handling logic. In particular, the clipboard object intent handling logic can include program code enabled to embed a reference to both a selected object and corresponding selectable action from a source into a target.

### BACKGROUND OF THE INVENTION

1. Field of the Invention

The present invention relates to the field of management of clipboard objects.

2. Description of the Related Art

Personal computing many decades ago enabled a Herculean advancement in productivity mostly in consequence of the ease in which personal computing devices permitted document creation and management. The word processor, the earliest of killer applications permitted the end user not only to craft the text of a document, but also to manipulate the placement of text through “cutting” and “pasting” from one portion of a document to another. In that early computing environments provided a mere character based, uni-tasking user interface, the act of cutting and pasting largely was limited to a single document, although during the twilight of the character based user interface era, terminate and stay resident applications permitted cutting and pasting not only across different documents in a single application, but also across different documents in respectively different applications.

The advent of the graphical user interface computing environment accelerated the growth of personal computing and supported the globalization of the ubiquity of the word processor. The clipboard became a focal point of the new environment, allowing for the intra-computer movement not only of textual data, but also other types of data including graphical objects. The general paradigm for cutting and pasting in a graphical user interface persists today more than twenty years subsequent to the widespread distribution of the first graphical user interface based personal computers—namely the selection of a document location through a pointing device such as a mouse, the activation of a context menu with the mouse and the commanding of a cut or copy operation followed by the placement of the mouse pointer in a different document location, the activation of a context menu with the mouse and the commanding of a paste operation.

### BRIEF SUMMARY OF THE INVENTION

Embodiments of the present invention address deficiencies of the art in respect to clipboard object management and provide a novel and non-obvious method, system and computer program product for clipboard handling of object intent for clipboard objects. In one embodiment of the invention, a clipboard data processing system can be configured for clipboard handling of object intent for clipboard objects. The system can include a clipboard agent managing a clipboard in an operating platform. The system further can include clipboard object intent handling logic. In particular, the clipboard object intent handling logic can include program code enabled to embed a reference to both a selected object and corresponding selectable action on the object from a source into a target.

In one aspect of the embodiment, a context menu of selectable actions can be provided, the menu corresponding to a selected object for placement into the clipboard. In another aspect of the embodiment, the selectable actions can vary and can include, for example, a reply directive, an edit directive, a view directive and a delete directive, to name only a few. In yet another aspect of the embodiment, the operating platform can include not only an operating system, but also a collaborative computing environment. Finally, in even yet another aspect of the embodiment, the target can include a calendar entry, a document, a workflow builder entry or an agent builder entry.

In another embodiment of the invention, a method for clipboard handling of object intent for clipboard objects can be provided. The method can include selecting an object in a source for placement into a clipboard, choosing an associated action from among a set of actions corresponding to the selected object, placing a reference to both the selected object and the chosen associated action into the clipboard, and pasting the reference to the selected object and the chosen associated action into a target such that activating the reference to the selected object causes an application of the associated action on the selected object. Optionally, pasting the reference to the selected object and the chosen associated action into a target such that activating the reference to the selected object causes an application of the associated action on the selected object, further can include prompting for permission to apply the associated action on the selected object responsive to the activating of the reference.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1A is a pictorial illustration of a clipboard data processing system configured for clipboard handling of object intent for clipboard objects;

FIG. 1B is a schematic illustration of a clipboard data processing system configured for clipboard handling of object intent for clipboard objects; and,

FIGS. 2A and 2B, taken together, are a flow chart illustrating a process for clipboard handling of object intent for clipboard objects.

### DETAILED DESCRIPTION OF THE INVENTION

Embodiments of the present invention provide a method, system and computer program product for clipboard handling of object intent for clipboard objects. In accordance with an embodiment of the present invention, a action for an object can be recorded in connection with an object selected for clipboard insertion. Thereafter, both the action identifier and the object can be inserted into the clipboard. When pasting the object from the clipboard into content, the action also can be inserted into the content in association with the pasted object such that a selection of the object in the content activates the action for operation on the object.

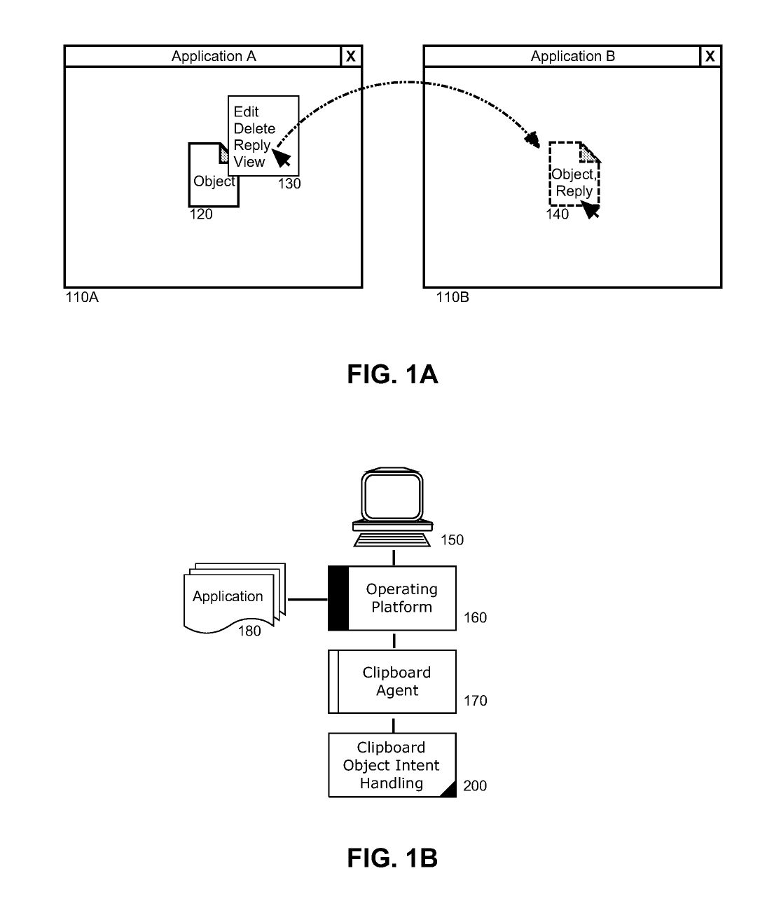

In illustration, FIG. 1A is a pictorial illustration of a clipboard data processing system configured for clipboard handling of object intent for clipboard objects. As shown in FIG. 1A, an object 120 within a first application 110A can be selected for processing. The selection can include a mouse click or a mouse over, for instance. Upon detecting a selection event, a context menu 130 can be provided indicating a list of available actions to be performed upon the object 120. Thereafter, a selected one of the actions can be copied into a second application 110B, for example by way of a drag-and-drop application. Consequently, a package 140 of the object 120 and the selected one of the actions in the context menu 130 can be pasted into the second application 110B.

In further illustration, FIG. 1 is a schematic illustration of a clipboard data processing system configured for clipboard handling of object intent for clipboard object. The system can include a client computing device 150. An operating platform 160 can be disposed in the client computing device 150 and can include, for example, an operating system, or a collaborative client end user environment, such as the Notes® end user environment manufactured by International Business Machines Corporation of Armonk, New York. The operating platform 160 can include a clipboard agent 170 also sometimes referred to as a clipboard manager. The clipboard agent 170 can be configured to provide for the short-term storage of data for transfer between applications, usually through an exercise of the cut-copy-paste troika of data sharing directives.

Notably, clipboard object intent handling logic 200 can be coupled to the clipboard agent 170. The clipboard object intent handling logic 200 can include program code enabled to detect an intent-based clipboard action such as the selection of an action along with an associated object. The action can include, for example, an open, view, edit, reply or delete action and the associated object can include a document, an e-mail message or an instant message, or a reference to a network-accessible artifact such as a Web page. The program code can be further enabled to copy both a reference to the action and the associated object into the clipboard and to insert the reference into the target. In this way, when the reference becomes activated, the action can be launched on the associated object from within the target.

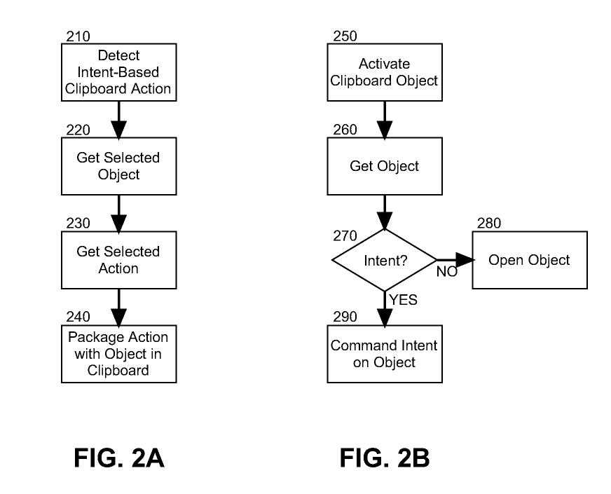

In further illustration, FIGS. 2A and 2B, taken together, are a flow chart illustrating a process for clipboard handling of object intent for clipboard objects. Considering first FIG. 2A, in block 210, an intent-based clipboard action can be detected in a source, for example the selection of a cut-copy-paste operation. In block 220, a selected object can be retrieved and in block 230, a corresponding action can be identified, for example reply, delete, edit or view. The corresponding action can be determined through the selection of a context menu of relevant actions, for example. Thereafter, in block 240, a reference to the selected object along with the corresponding action can be packaged into the clipboard. As such, the package can be embedded in one or more targets using the paste or paste special mechanism of the clipboard agent managing the clipboard. In this regard, the targets can include shared documents, calendar entries, agent builder entries and workflow builder entries, to name only a few possibilities.

Turning now to FIG. 2B, in block 250, a clipboard object can be activated from within a target. In response, in block 260 a referenced object within the clipboard object can be retrieved. In decision block 270, it can be determined whether an intent has been specified for the retrieved object in the form of a packaged action associated with the reference to the object. If not, in block 280 the object can be acted upon according to the default behavior assigned to the retrieved object—generally a “file | open” directive. However, if an intent has been specified, in block 290, the action associated with the retrieved object can be applied to the retrieved object, such as an edit, delete, reply or view directive. The application of the associated action can be automatically applied, or manually applied when prompted by the clipboard agent.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

I claim:

1. A clipboard data processing system configured for clipboard handling of object intent for clipboard objects, the system comprising:
a clipboard agent managing a clipboard in an operating platform; and,
clipboard object intent handling logic comprising program code enabled to embed a reference to both a selected object and corresponding selectable action from a source into a target.

2. The system of claim 1, further comprising a context menu of selectable actions corresponding to a selected object for placement into the clipboard.

3. The system of claim 2, wherein the selectable actions comprise a reply directive.

4. The system of claim 2, wherein the selectable actions comprise an edit directive.

5. The system of claim 2, wherein the selectable actions comprise a view directive.

6. The system of claim 2, wherein the selectable actions comprise a delete directive.

7. The system of claim 1, wherein the operating platform comprises a collaborative computing environment.

8. The system of claim 1, wherein the target comprises a calendar entry.

9. The system of claim 1, wherein the target comprises a document.

10. The system of claim 1, wherein the target comprises one of a workflow builder entry and an agent builder entry.

11. A method for clipboard handling of object intent for clipboard objects, the method comprising:
selecting an object in a source for placement into a clipboard;
choosing an associated action from among a set of actions corresponding to the selected object;
placing a reference to both the selected object and the chosen associated action into the clipboard; and,
pasting the reference to the selected object and the chosen associated action into a target such that activating the reference to the selected object causes an application of the associated action on the selected object.

12. The method of claim 11, wherein pasting the reference to the selected object and the chosen associated action into a target such that activating the reference to the selected object causes an application of the associated action on the selected object, further comprises prompting for permission to apply the associated action on the selected object responsive to the activating of the reference.

13. A computer program product comprising a computer usable medium embodying computer usable program code for clipboard handling of object intent for clipboard objects, the computer program product comprising:
computer usable program code for selecting an object in a source for placement into a clipboard;
computer usable program code for choosing an associated action from among a set of actions corresponding to the selected object;
computer usable program code for placing a reference to both the selected object and the chosen associated action into the clipboard; and,
computer usable program code for pasting the reference to the selected object and the chosen associated action into a target such that activating the reference to the selected object causes an application of the associated action on the selected object.

14. The computer program product of claim 13, wherein the computer usable program code for pasting the reference to the selected object and the chosen associated action into a target such that activating the reference to the selected object causes an application of the associated action on the selected object, further comprises computer usable program code for prompting for permission to apply the associated action on the selected object responsive to the activating of the reference.
